(19) United States
(12) Patent Application Publication
(10) Pub. No.: US 2018/0329924 A1
(43) Pub. Date: Nov. 15, 2018

(54) INFORMATION PROCESSING APPARATUS, PROGRAM, TERMINAL, AND DISPLAY CONTROL METHOD

(71) Applicant: LINE Corporation, Tokyo (JP)

(72) Inventor: Daisuke ASAI, Tokyo (JP)

(73) Assignee: LINE Corporation, Tokyo (JP)

(21) Appl. No.: 16/046,151

(22) Filed: Jul. 26, 2018

Related U.S. Application Data
(63) Continuation of application No. PCT/JP2017/002942, filed on Jan. 27, 2017.

(30) Foreign Application Priority Data
Jan. 29, 2016 (JP) 2016-016345

(51) Int. Cl. G06F 17/30

(52) U.S. Cl. CPC G06F 17/30241; G06F 17/30554; G06F 3/0482; G06F 17/30867; G06F 17/3087

(57) ABSTRACT

An information processing apparatus includes a receiver configured to receive from a terminal a display request that includes information on a reference position and a search word; an extractor configured to extract a search result based on the reference position and the search word; a display controller configured to identify an attribute associated with the extracted search result, and to issue a command to the terminal to display information representing the attribute at a position corresponding to the search result on a map displayed on a screen of the terminal. The display controller adjusts a type and/or a quantity of the information representing the attribute to be displayed depending on a distance between the reference position and the position corresponding to the extracted search result.

### CROSS-REFERENCE TO RELATED APPLICATIONS

This application is a continuation application of International Application PCT/JP2017/002942 filed on Jan. 27, 2017 and designated the U.S., which is based upon and claims the benefit of priority of Japanese Patent Application No. 2016-016345 filed on Jan. 29, 2016, the entire contents of which are incorporated herein by reference.

### FIELD

The present disclosure relates to an information processing apparatus, a program, a terminal, and a display control method.

### BACKGROUND

Displaying a POI (Point Of Interest), such as a store or a sightseeing spot, on a map currently displayed on a terminal such as a smart phone has been widespread.

For example, when a map application of a terminal receives a search request regarding a nearby “convenience store” from the user of a terminal, a terminal obtains information regarding the position of a nearby convenience store from an information processing apparatus such as a server, to display it on the map by using a mark of an icon or the like.

Also, it has been proposed to change an icon display on a map depending on the distance between a reference position, such as a current position or the like, and a POI. For example, a method has been proposed that displays an icon larger for a POI closer to the current position, and displays an icon smaller for a POI more separated from the current position (see, for example, Japanese Laid-Open Patent Publication 2011-22077).

However, although it is possible for such a conventional implementation to change a displaying form of a POI depending on the distance, it has not been performed to adjust the type and/or the quantity of information regarding a POI to be displayed depending on the distance.

Among POIs displayed on a map, the user of the terminal needs more information for determining whether to visit a POI located closer to the reference position, whereas it is often the case that information on a POI farther from the reference position is unnecessary.

### SUMMARY

According to an aspect, an information processing apparatus includes a receiver configured to receive from a terminal a display request that includes information on a reference position and a search word; an extractor configured to extract a search result based on the reference position and the search word; a display controller configured to identify an attribute associated with the extracted search result, and to issue a command to the terminal to display information representing the attribute at a position corresponding to the search result on a map displayed on a screen of the terminal. The display controller adjusts a type and/or a quantity of the information representing the attribute to be displayed depending on a distance between the reference position and the position corresponding to the extracted search result.

### BRIEF DESCRIPTION OF DRAWINGS

FIG. 1 is a system configuration diagram of an information processing system according to a first embodiment;

FIG. 2 is a diagram illustrating a first example of a sequence of operations according to the first embodiment;

FIG. 3 is a diagram illustrating an example of a POI management table according to the first embodiment;

FIG. 4 is a diagram illustrating a first example of a map displayed on the screen of a terminal according to the first embodiment;

FIG. 5 is a diagram illustrating a second example of a sequence of operations according to the first embodiment;

FIG. 6 is a diagram illustrating an example of a friend management table according to the first embodiment;

FIG. 7 is a diagram illustrating an example of a customer correspondence table according to the first embodiment;

FIG. 8 is a diagram illustrating a second example of a map displayed on the screen of a terminal according to the first embodiment;

FIG. 9 is a diagram illustrating a third example of a sequence of operations according to the first embodiment;

FIG. 10A is a diagram illustrating an example of a target management table according to the first embodiment;

FIG. 10B is a diagram illustrating an example of a user attribute management table according to the first embodiment;

FIG. 11 is a diagram illustrating a third example of a map displayed on the screen of a terminal according to the first embodiment;

FIG. 12 is a diagram illustrating an example of a hardware configuration of an information processing apparatus according to the first embodiment;

FIG. 13 is a diagram illustrating an example of a hardware configuration of a terminal according to the first embodiment;

FIG. 14 is a diagram illustrating an example of a functional configuration of an information processing apparatus according to the first embodiment;

FIG. 15 is a diagram illustrating an example of a functional configuration of a terminal according to the first embodiment;

FIG. 16 is a diagram illustrating a first example of a flow of operations according to the first embodiment;

FIG. 17 is a diagram illustrating a first example of a flow of operations according to the first embodiment;

FIG. 18 is a diagram illustrating an example of a functional configuration of an information processing apparatus according to a second embodiment; and

FIG. 19 is a diagram illustrating an example of a functional configuration of a terminal according to the second embodiment.

### DESCRIPTION OF EMBODIMENTS

In the following, embodiments will be described with reference to the drawings. According to an embodiment, it is possible to adjust the type and/or the quantity of information regarding the position of a POI to be displayed on a map, depending on the distance from the reference position.

### First Embodiment

<System Configuration>

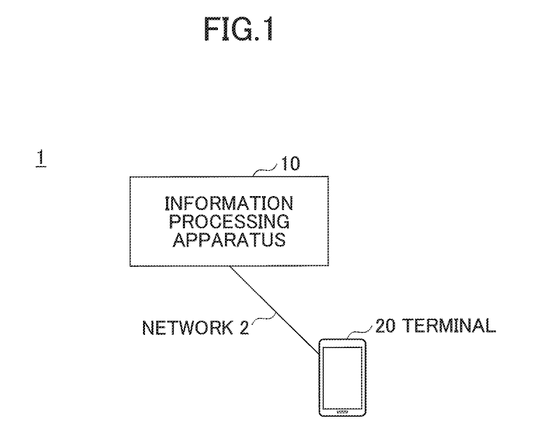

FIG. 1 is a diagram illustrating a system configuration of an information processing system 1 according to a first embodiment. The information processing system 1 includes an information processing apparatus 10 and a terminal 20. The information processing apparatus 10 and the terminal 20 are connected to each other through a network 2. The network 2 may include a wired network and a wireless network.

The information processing apparatus 10 is implemented by, for example, a server. The terminal 20 is a smart phone, a tablet terminal, a PC (Personal Computer), a cellular phone, a console for games, a touchpad, an electronic reader, a wearable terminal, or the like.

For the user of the terminal 20, the information processing apparatus 10 provides an information providing service associated with a map displayed on the terminal 20. The information processing apparatus 10 also provides an SNS (Social Network Service). By installing a map application on the terminal 20 and by connecting with the information processing apparatus 10, the user of the terminal 20 can receive the information providing service associated with a map from the information processing apparatus 10. Also, by installing an SNS application on the terminal 20 in addition to the map application, the user of the terminal 20 can have the information providing service associated with a map interoperate with the SNS. A method of interoperation will be described later.

<First Example of Display Controlling>

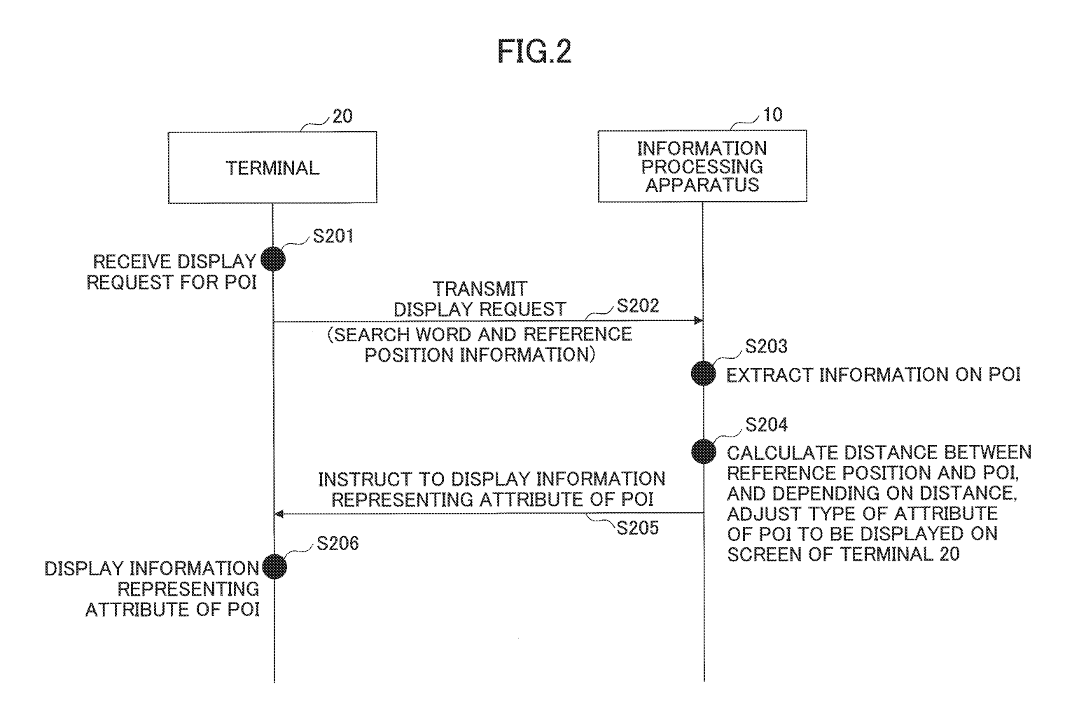

A first example of display controlling will be described by using FIG. 2 through FIG. 4. The first example of display controlling is characterized by changing a displaying form of a POI (Point Of Interest) that represents a facility such as a store, a sightseeing spot, or the like on a map displayed on the terminal 20, depending on the distance from a reference position such as the current position of the terminal 20 or the like.

FIG. 2 is a diagram illustrating a sequence of operations according to the first embodiment. By using FIG. 2, an information providing service will be described according to the first embodiment.

At Step S201, the terminal 20 activates the map application in response to a command from the user. Next, the terminal 20 receives a display request of a POI. Here, assume that as a display request, “Western-style restaurant” has been received as input from the user.

At Step S202, the terminal 20 transmits the display request to the information processing apparatus 10. The display request includes positional information (reference position information) used as a reference such as the current position of the terminal 20 or the like and an input keyword (search word) of “Western-style restaurant”. As the positional information used as the reference, information on the latitude and the longitude, the address, or the name of a place may be used.

The terminal 20 may receive the reference position information from the user. For example, in the case where the terminal 20 receives as input the name of a place “OO station”, the terminal 20 transmits a display request that includes “OO station” as the reference position information.

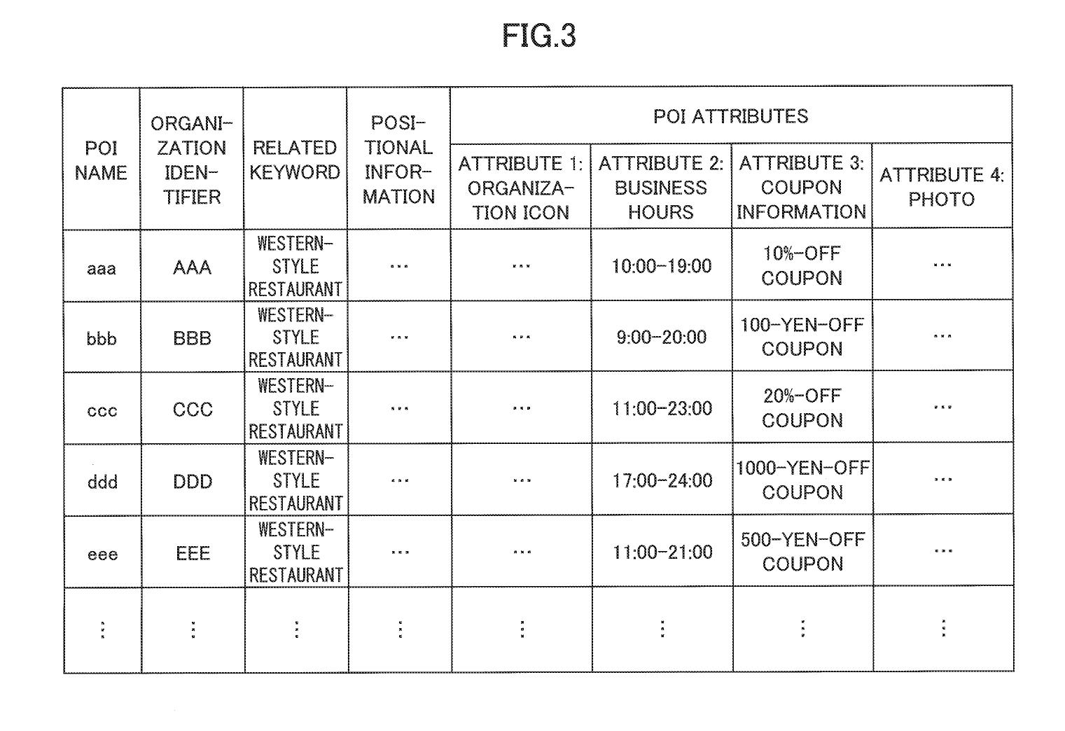

At Step S203, the information processing apparatus 10 extracts information on each POI that is associated and stored with the keyword “Western-style restaurant” from a POI management table. In other words, the information processing apparatus 10 extracts each POI associated with the keyword as a “search result”. An example of the POI management table is illustrated in FIG. 3. In the POI management table in FIG. 3, “POI name”, “organization identifier”, “related keyword”, “positional information”, and “POI attribute information” are associated with each other, to be stored.

The “POI name” is a name of a POI displayed on a map; for example, a store name corresponding to the POI is set. The “organization identifier” is an identifier that represents an organization to which the POI belongs. For example, an identifier of a chain store or a brand to which the store belongs is set. In the case where the store corresponding to the POI is a store of a predetermined brand “AAA Sports”, the identifier of “AAA Sports” is set. The “related keyword” is set with a keyword relevant to a POI, and the information processing apparatus 10 uses the related keyword to extract a POI that is a subject of a display request. The “positional information” is set with positional information on a POI. The information to be set is substantially the same as the reference position information.

Attributes of the POI are set to the POI attribute information. FIG. 3 illustrates an example in which an icon of an organization to which a POI belongs (“organization icon”) is set as an attribute 1, business hours of the POI is set as an attribute 2, coupon information on the POI is set as an attribute 3, and a photograph of the POI is set as an attribute 4. In the example in FIG. 3, although four attributes are set, the number of attributes to be stored can be set discretionarily.

At Step S204, from received reference position information and positional information on each extracted POI, the information processing apparatus 10 calculates the distance between a position used as a reference and the POI. Next, the information processing apparatus 10 determines to cause the terminal 20 to display each POI that exists in a predetermined distance from the reference position. Also, depending on a calculated distance, the information processing apparatus 10 adjusts types of attributes of the POI to be displayed on the screen of the terminal 20.

For example, the information processing apparatus 10 determines to display POIs within 1 km from the reference position. Then, the information processing apparatus 10 may adjust displaying aspects such that each POI that exists within 300 m from the reference position is displayed on a map so that information representing the attribute 1 to the attribute 4 can be recognized by the user of the terminal 20; each POI that exists within 500 m from the reference position is displayed on the map so that information representing the attribute 1 and the attribute 2 can be recognized by the user of the terminal 20; and each POI that exists away from the reference position by 500 m or farther is displayed without information representing the attributes, but with a mark with which the existence of the POI can be recognized.

At Step S205, the information processing apparatus 10 issues a command to the terminal 20 to display information that represents the attributes of the extracted POIs. At this time, the information processing apparatus 10 transmits to the terminal 20 the organization icon (attribute 1), the photograph (attribute 4), and the like of each POI that are necessary to display the screen of the terminal 20.

At Step S206, the terminal 20 displays information that represents the attributes of the POIs on the map on the screen. Here, the information that represents the attributes may be presented by using an icon, a mark, and the like so as to be recognized by the user of the terminal 20.

Note that when detecting that the reference position has been changed by a movement of the terminal 20 or by receiving input from the user, the terminal 20 indicates the change of the reference position to the information processing apparatus 10. In response to receiving the indication, the information processing apparatus 10 executes Step S203 through Step S205 again.

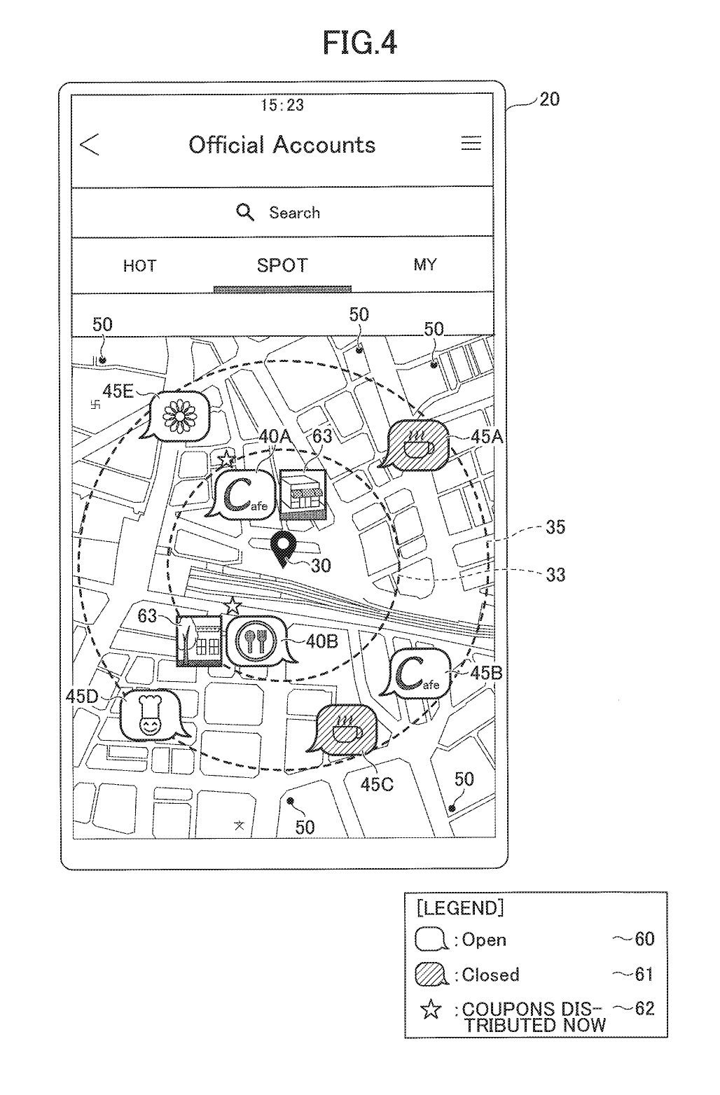

FIG. 4 is a diagram illustrating an appearance of a map on the screen of the terminal 20 on which attributes of POIs are displayed in respective displaying forms that can be recognized by the user of the terminal 20.

The reference position is illustrated by a mark 30 in FIG. 4. A range within 300 m from the reference position is designated as a range 33 and a range within 500 m from the reference position is designated as a range 35.

POIs in the range within 300 m from the reference position are displayed by using information that represents the attribute 1 to the attribute 4. Specifically, each POI 40 may be displayed on a map with an organization icon 40 (attribute 1); a mark 60 representing that it is open or a mark 61 representing that it is closed (attribute 2); a mark 62 representing that coupons are currently distributed (attribute 3); and a photograph 63 of the POI 40 (attribute 4). Note that in the case where no value is set to the attribute 3 of a POI 40 in the POI management table, the POI 40 is not displayed with a mark representing that coupons are currently distributed.

Each POI that is away from the reference position by 300 m or farther and within 500 m from the reference position may be displayed with an organization icon 45 (attribute 1) and a mark 60 representing that it is open or a mark 61 representing that it is closed (attribute 2).

Each POI that is away from the reference position by 500 m or farther is displayed by a mark 50 representing that the POI exists.

Note that which of a mark 60 representing that it is open or a mark 61 representing that it is closed is to be displayed may be determined by the information processing apparatus 10 that issues a command to the terminal 20, or by the terminal 20 by obtaining business hours of each POI from the information processing apparatus 10.

Also, the information processing apparatus 10 may issue a command to the terminal 20 to change a displaying form of a mark 62 representing that coupons are currently distributed so as to reflect the extent of a good bargain of the coupons such as the discount rate or the discount amount of coupons. For example, the information processing apparatus 10 may further highlight a mark 62 when displaying if the extent of a good bargain is higher.

According to the first example, a POI closer to the reference position, which can be considered to have a higher likelihood that the user visits the POI, is displayed by using information that represents a greater variety of attributes of the POI on a map. This enables the user of the terminal 20 to select the POI to visit more easily. Also, while a POI closer to the reference position is displayed by using information that represents a greater variety of attributes of the POI, the variety of attributes becomes less if the POI is located further away from the reference position. For this reason, the visibility is not impaired for the user of the terminal 20 when confirming the map.

<Second Example of Display Controlling>

In the first example of display controlling, the information processing apparatus 10 extracts a POI based on a keyword included in a display request, determines a displaying form of the POI on a map depending on the distance from the reference position, and displays the POI on the screen of the terminal 20. In a second example of display controlling, in addition to the embodiment of the first example of display controlling, a social networking service interoperates with an information providing service on a map.

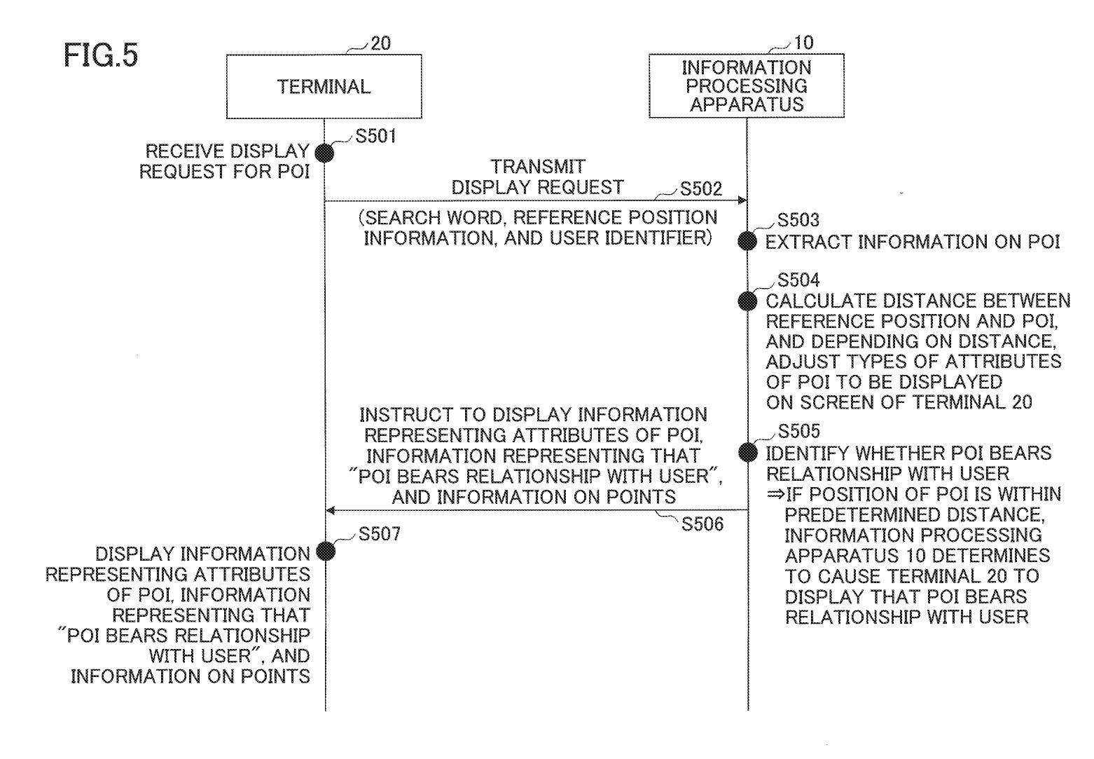

Specifically, a displaying form of a POI on a map is determined based on a relationship between the POI and the user of the terminal 20. An embodiment according to the second example of display controlling will be described by using FIG. 5 through FIG. 7. Note that description of a part that overlaps the first example of display controlling is omitted, and only a different part will be described.

A sequence of operations in the second example of display controlling will be described by using FIG. 5.

Step S501 is processed in the same way as Step S201.

At Step S502, the terminal 20 transmits a display request to the information processing apparatus 10. The display request includes reference position information, an input keyword, and the identifier of the user of the terminal 20.

Step S503 and Step S504 are processed in the same way as Step S203 and Step S204.

At Step S505, the information processing apparatus 10 refers to a friend management table, to identify whether a POI determined at Step S504 to be displayed on a map bears a relationship with the user. Here, “bearing a relationship” includes that a POI or an organization to which the POI belongs is registered on the user's terminal 20 as a “favorite”; the user is registered as a member; and the POI or the organization to which the POI belongs bears a relationship of “friend” with the user of the terminal 20 on an SNS. Here, bearing a relationship of “friend” on an SNS means, for example, that a POI or an organization to which the POI belongs is registered as a “friend” in an account of the user of the terminal 20 on the SNS.

In the case where a store corresponding to a POI or an organization to which the store belongs is identified to bear a relationship with the user, the information processing apparatus 10 determines whether to display that “the POI bears a relationship with the user” on the screen of the terminal 20.

In the case where the position of a POI that bears a relationship with the user is within a predetermined distance from the reference position (for example, within 500 m), the information processing apparatus 10 determines to display that “the POI bears a relationship with the user” on the terminal 20.

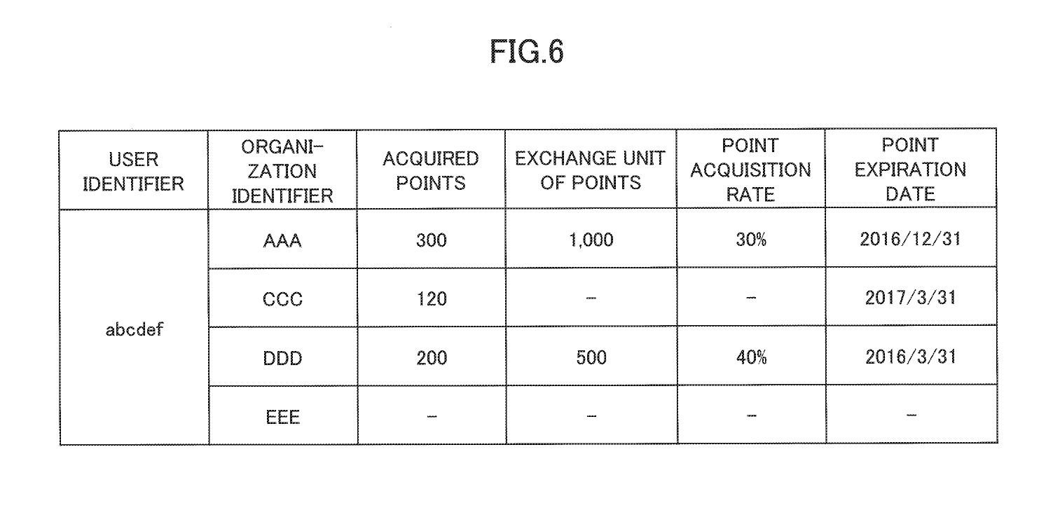

FIG. 6 illustrates an example of the friend management table. In the friend management table in FIG. 6, identifiers of organizations with which the user bears a relationship of “friend” on an SNS are associated with the user ID, to be stored. Also, in the case where an associated organization gives the user points based on use of the service or purchase of goods, acquired points, an exchange unit of points, a point acquisition rate, and a point expiration date are stored for each of such organizations. Here, the acquired points represent the number of points that have been given to the user, and the exchange unit of points represents the number of points with which the user can receive provision of a service or exchange free gifts as compensation. The point acquisition rate represents a value obtained by dividing the acquired points by the exchange unit of points. The point expiration date is information that represents a due date until which the user can use the points at the store or the like. The information processing apparatus 10 may determine to display information that represents these points on the terminal 20, in addition to the information that “the POI bears a relationship with the user”.

At Step S506, the information processing apparatus 10 issues a command to the terminal 20 to display information that represents the attributes of extracted POIs so as to be recognized by the user of the terminal 20 (similar to Step S205). Also, the information processing apparatus 10 issues a command to display information representing that “the POI bears a relationship with the user” and information regarding the points of the organization to which the POI belongs so as to be recognized by the user of the terminal 20. This command may also include information that indicates the points to be displayed, for example, the point acquisition rate.

At Step S507, in addition to information that represents the attribute of each POI, the terminal 20 displays information representing that “POI bears a relationship with the user”, and information regarding points on the map on the screen.

The information processing apparatus 10 may issue a command to the terminal 20 to adjust a display on the map of the screen for each POI within a predetermined distance from the reference position (for example, 500 m), based on a customer correspondence state at the POI.

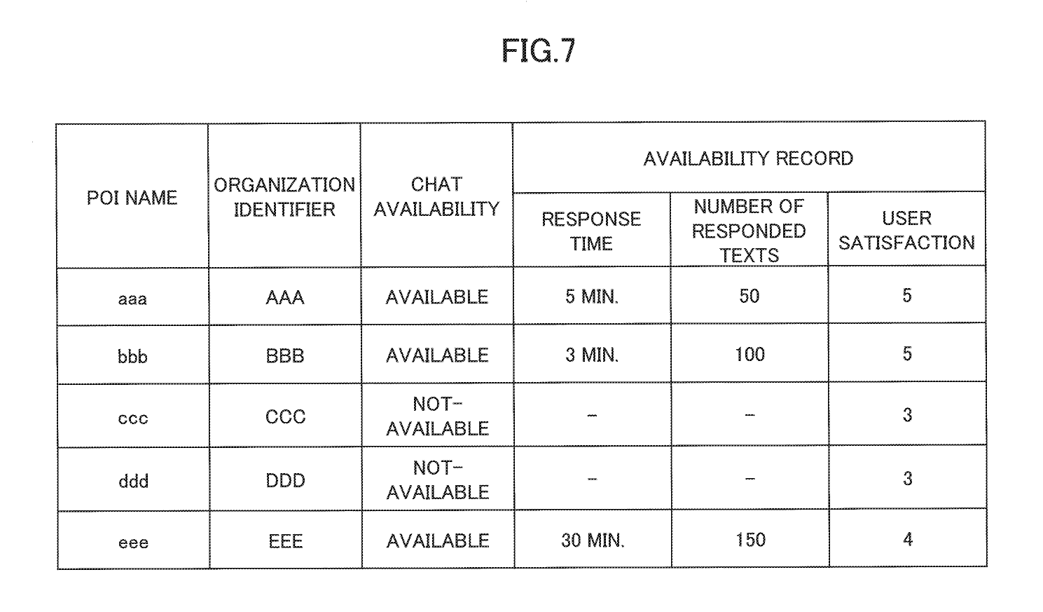

For example, the information processing apparatus 10 may hold a customer correspondence table illustrated in FIG. 7, to determine a displaying form of an extracted POI on a map based on a customer correspondence state at the POI.

Here, “POI name”, “organization identifier”, “chat availability”, and “availability record” of a POI are associated with each other to be stored in the customer correspondence table in FIG. 7.

Information that represents whether an inquiry using a one-to-one chat on an SNS is available at the POI is set to “chat availability”.

A result of evaluation by other users of a store corresponding to the POI is recorded in the “availability record”. In the example in FIG. 7, “response time”, “number of responded texts”, and “user satisfaction” are stored in the “availability record”. Note that the “availability record” may be stored for each organization to which a store belongs.

At Step S505, in addition to determining whether to display information representing that “the POI bears a relationship with the user”, the information processing apparatus 10 may refer to the customer correspondence table to determine whether to change a displaying form depending on the availability of chat and the contents of the availability record. In this case, determined contents are indicated to the terminal 20 at Step S506, which are then displayed on the map on the screen of the terminal 20 at Step S507 by displaying forms that can be recognized by the user of the terminal 20.

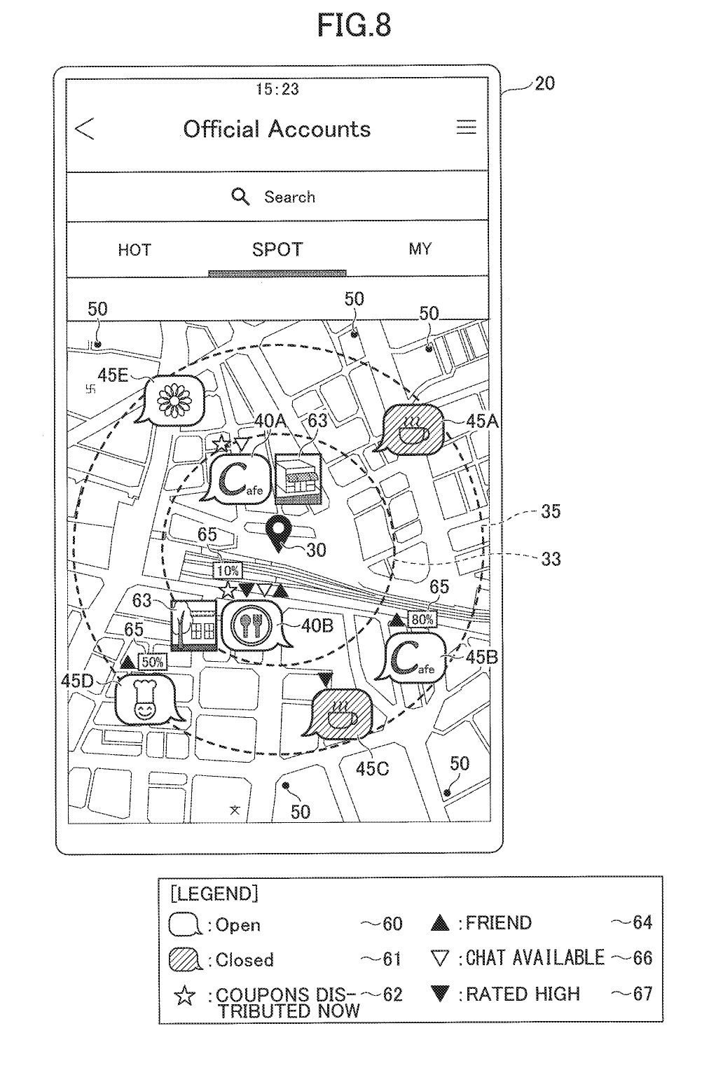

FIG. 8 illustrates an example of a map displayed on the screen of the terminal 20 according to the second example of display controlling.

FIG. 8 illustrates an appearance of a map on the screen of the terminal 20 on which in the case where “the POI bears a relationship with the user”, POIs within 500 m from the reference position (mark 30) are displayed along with information representing the relationship, the point acquisition rate, and the attributes regarding the POI. In this case, POIs designated with organization icons 40B, 45B, and 45D bear relationships with the user, and marks (friend marks 64) representing the relationships, and respective point acquisition rates 65 are displayed with the organization icons (40, 45).

The appearance of the map on the screen of the terminal 20 in FIG. 8 also exhibits that the POIs within 500 m from the reference position (mark 30) are displayed along with marks representing the availability of chat and high evaluations by customers, and organization icons 40 and the like. In this case, POIs designated with organization icons 40A and 40B are displayed with marks 66 representing the chat availability, and POIs designated with organization icons 40B and 45C are displayed with marks 67 representing a high user satisfaction.

Although not illustrated in FIG. 8, a point expiration date may be displayed with a friend mark 64. In this case, the displaying form of a point expiration date may be changed depending on a period before expiration of the points. For example, in the case where the points will expire within a week, in order to draw attention of the user of the terminal 20, the expiration date may be presented in red. Also, a mark representing a low user satisfaction may be displayed on the map, and a mark representing the length of the response time and the length of responded texts may be displayed on the map.

Although a relationship between an organization to which a store belongs and the user is managed in the friend management table in FIG. 6, a relationship between a store itself and the user may be managed in the friend management table.

According to the second example of display controlling, in addition to the effects of the first example of display controlling, a relationship between the user of the terminal 20 and a POI is displayed. Therefore, it becomes easier for the user to identify a store corresponding to the POI with which the user bears a relationship, for example, a frequently visited store. Also, since information that represents the points at a store is displayed on the map, the user of the terminal 20 may be further encouraged to visit the store.

<Third Example of Display Controlling>

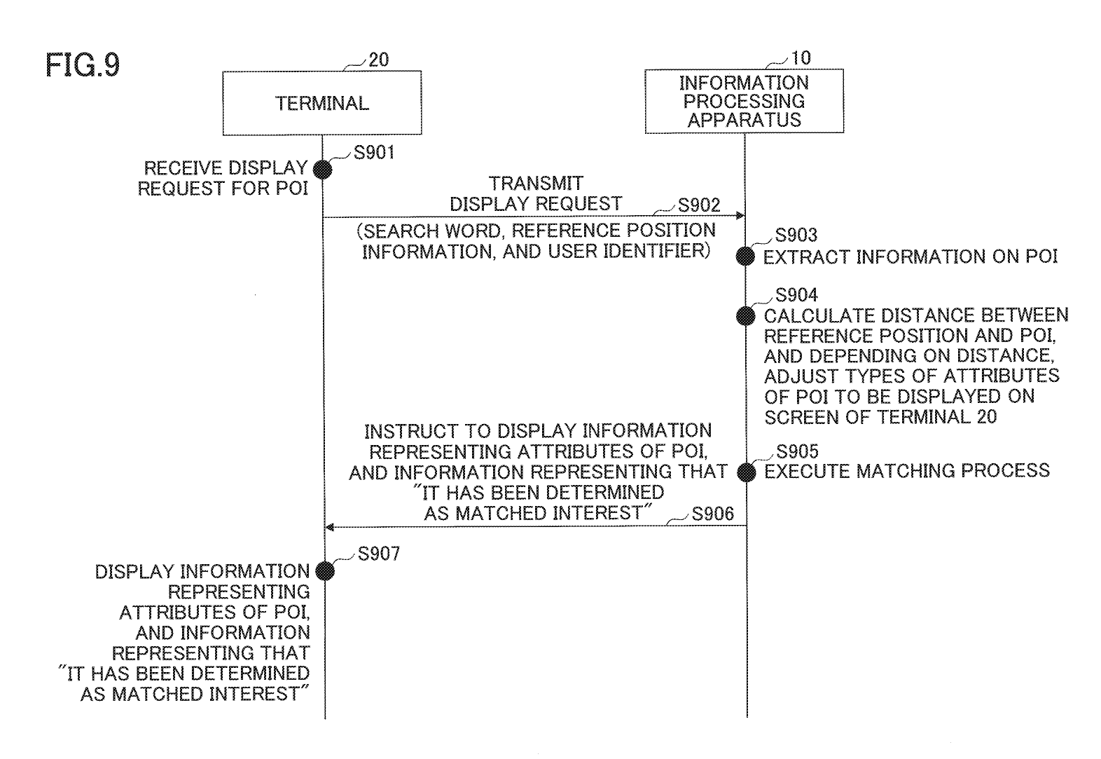

In a third example of display controlling, in addition to the embodiments of the first example of display controlling and the second example of display controlling, the information processing apparatus 10 executes matching between the attributes of the user of the terminal 20 and users targeted by a POI, to determine a displaying form. An embodiment according to the third example of display controlling will be described by using FIG. 9 through FIG. 11. Note that description of a part that overlaps the first and second examples of display controlling is omitted, and only a different part will be described.

FIG. 9 is a diagram illustrating a sequence of operations according to the third example of display controlling.

Step S901 through Step S904 are processed in the same way as Step S501 through Step S504.

At Step S905, the information processing apparatus 10 refers to a target management table and a user attribute management table, to execute a process (matching process) of determining whether a customer segment targeted by a store corresponding to a POI that has been identified to be located within a predetermined distance (for example, within 500 m) from the reference position or an organization to which the store belongs matches the attributes of the user of the terminal 20.

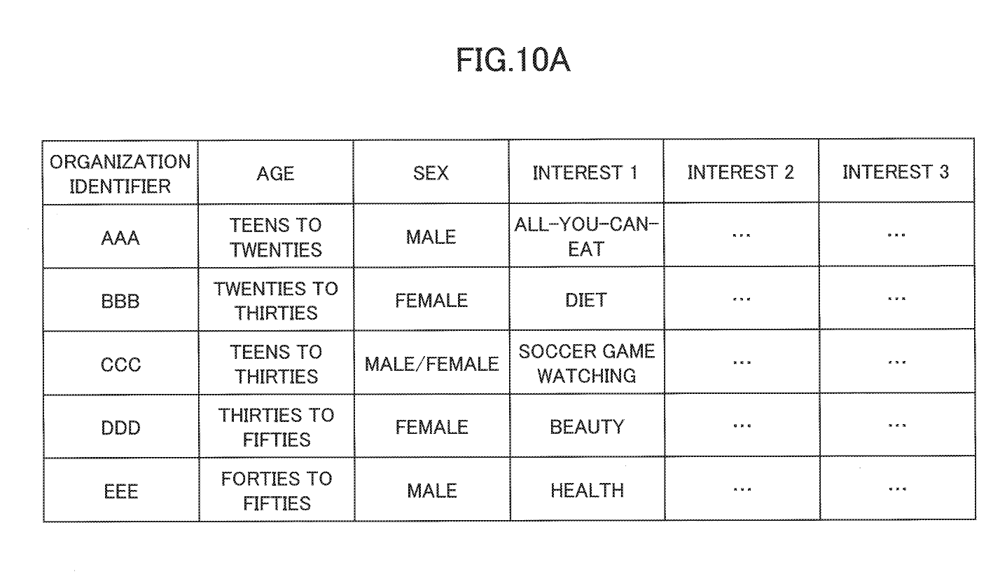

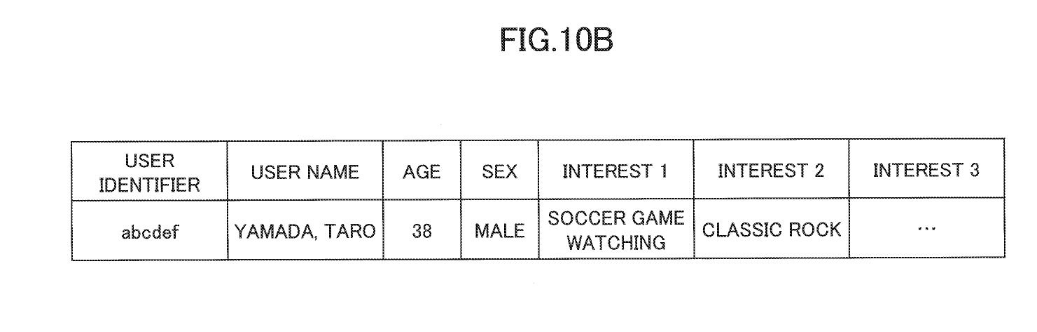

FIG. 10A illustrates an example of the target management table. In the target management table in FIG. 10A, each organization identifier is associated with “age”, “sex”, and interests (“interest 1”, “interest 2”, and “interest 3”) of target customers in terms of services and products provided by the organization, to be stored. Here, an interest is one of the interests of target customers assumed by a manager of the organization. The interest may be set based on an interest of a customer to whom a service has been provided or a product has been sold. The number of interests may be set discretionarily. Although FIG. 10A illustrates a case where a target is set for each organization, it is needless to say that the target can be set for each store.

FIG. 10B illustrates an example of the user attribute management table. In the user attribute management table in FIG. 10B, “user ID”, “user name”, “age” of the user, “sex” of the user, interests of the user (“interest 1”, “interest 2”, and “interest 3”) are associated with each other, to be stored. Here, as the interest, a hobby, a favorite food, or any matter of interest, of the user is set.

A matching process will be specifically described by using the target management table and the user management table illustrated in FIGS. 10A-10B.

The information processing apparatus 10 identifies information on customers targeted by an organization to which a store corresponding to a POI belongs that has been extracted as a result of Step S904, by using the target management table. Here, assume that organization identifiers “AAA”, “BBB”, “CCC”, “DDD”, and “EEE” have been extracted as organizations to which POIs belong as a result of Step S904.

Also, the information processing apparatus 10 identifies the attributes of the user of the terminal 20 who has transmitted a display request, by using the user attribute management table. Here, assume that a display request has been transmitted from the user of the terminal 20 having the user ID of “abcdef”.

The information processing apparatus 10 refers to the target management table and the user management table, to determine that the user having the user ID of “abcdef” matches the target customers of an organization having the identifier of “CCC”.

At Step S906, the information processing apparatus 10 issues a command to the terminal 20 to display the extracted POIs by using information that represents the attributes of POIs so as to be recognized by the user of the terminal 20. Also, the information processing apparatus 10 issues a command to display a POI determined as a match as a result of the matching process, by using the information representing the match.

Note that although the target management table in FIG. 10A is generated for each organization, the target management table may be stored for each organization, or may be stored for each POI such as a store.

At Step S907, the terminal 20 displays information representing a matched interest (a mark or the like) on the map on the screen, in addition to the information representing the attributes of the POI. Here, information representing a matched interest means that the attributes of users targeted by a store or the like match the attributes of the user of the terminal 20.

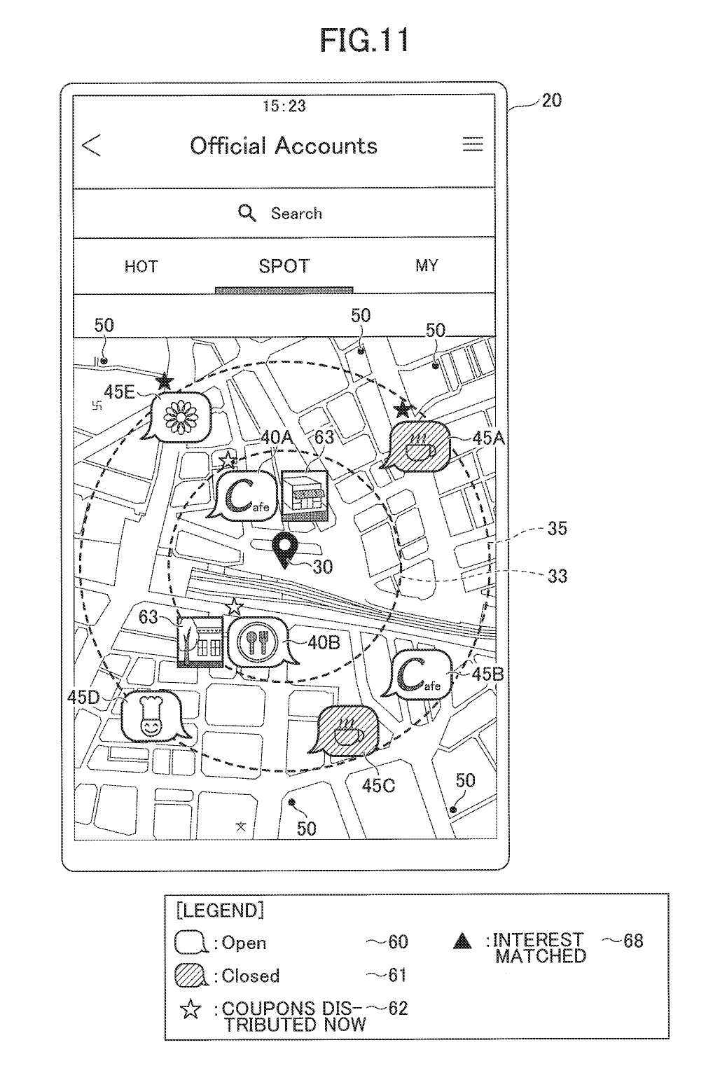

FIG. 11 illustrates an example of a map displayed on the screen of the terminal 20 according to the third example of display controlling.

FIG. 11 illustrates an appearance of POIs that are determined by the information processing apparatus 10 as located within 500 m from the reference position (mark 30), and as matches as a result of a matching process, and are displayed with marks (matched interest marks) representing that interests have matched. In this case, as a result of a matching process, POIs designated with the organization icons 45A and 45E have been determined as matched interests, and are displayed with marks (matched interest marks 68) representing that interests have matched.

According to the third example of display controlling, in addition to the effects of the first example of display controlling, executing a matching process between the user of the terminal 20 and stores and the like corresponding to the POIs enables to display POIs matching a need of the user, and enables the user to select a POI to be visited more easily.

<Fourth Example of Display Controlling>

Although in the examples of display controlling described above, the example of displaying the relationship with the user and POIs (the second example of display controlling), and the example of displaying a result of a matching process (the third example of display controlling) have been described separately, control of these may be executed simultaneously.

For example, after Step S201 through Step S204 have been executed, Step S505 and Step S905 may be executed. Then, the information processing apparatus 10 issues a command to the terminal 20 to display each extracted POI by using information that represents the attributes of the POI; for each POI that bears a relationship with the user of the terminal 20, issues a command to display the information representing that “the POI bears a relationship with the user”; and for each POI having a matched interest, issues a command to display the information representing “matched interest”.

This enables to display friend marks 64, matched interest marks 66, and the like on a map currently displayed on the terminal 20 along with icons, marks, photographs (40, 45, 60, 61, 62, 63), and the like representing the attributes of POIs.

Although the above examples of display controlling have been described with the examples that display the attributes of POIs as icons, marks, photographs on a map, the display method is not limited to icons, marks, and the like as long as the user of the terminal 20 can recognize the attributes of POIs and the like. For example, icons may be highlighted, changed in color, or animated so that the attributes and the like can be recognized; texts may be used; and a combination of these may be used for recognition. Also, based on a relationship between the user and a POI and/or a result of a matching process, display controlling may be executed to magnify or to reduce icons, and to display or not to display POIs on a map.

Although the above examples of display controlling have been described in a case where the types of attributes of a POI to be displayed are changed depending on the distance from the reference position, the quantity of information regarding the attributes of a POI may be adjusted, and the types and the quantity of information may be adjusted. Here, the quantity of information includes, for example, business hours, campaign information, provided menus, and the like, of a store or the like corresponding to a POI.

In the case where a number of POIs are extracted, the information processing apparatus 10 may adjust a response to a display request to be indicated to the terminal 20 so that the number of POIs displayed on the screen of the terminal 20 becomes less than or equal to a predetermined number, depending on the existence of a relationship with the user of the terminal 20, the existence of coupons, user satisfaction, and the like.

Note that the information processing apparatus 10 may indicate display parts such as marks and icons to be displayed on a map to the terminal 20 in advance to indicate the identifiers of the respective display parts when responding to a display request, or may indicate the display parts when responding to a display request.

<Operations when POI is Selected>

Next, operations will be described when a POI currently displayed on a map of the terminal 20 is selected.

The terminal 20 may start interoperating with an SNS in response to receiving a selection of a POI by a tap operation or the like performed by the user. For example, in response to receiving a selection of a POI, the terminal 20 may activate a chat menu of the SNS for exchanging messages with a store corresponding to the POI, or may activate a reservation menu. Also, the terminal 20 may obtain a coupon from the SNS account of the store corresponding to the POI. In the case where the user of the terminal 20 does not bear a relationship with a store corresponding to the POI selected by the user or an organization to which the store belongs, for example, in the case where a relationship of “friend” is not established on the SNS, the terminal 20 may activate a menu to establish a relationship on the SNS.

When the terminal 20 indicates to the information processing apparatus 10 that a selection of a POI has been received from the user, in response to receiving the indication, the information processing apparatus 10 may extract users who bear relationships with stores or organizations corresponding to the selected POI, and also bear relationships with the user of the terminal 20, to indicate a list of the extracted users to the terminal 20. The terminal 20 may display the indicated list, and consequently, the user of the terminal 20 can recognize the stores and the like bearing the relationships with the other users, and may be encouraged to visit one of the stores.

The map application of the terminal 20 may start a navigation to a destination location in response to receiving a selection of a POI. At this time, the terminal 20 may activate a chat menu with a store corresponding to the POI. This enables the user of the terminal 20 to make an inquiry to the store while moving.

In response to receiving a selection of a POI, the terminal 20 may access an SNS account of a store or the like corresponding to the POI, to display detailed information on the screen.

As described above, running an SNS application in response to a selection of a POI enables the user of the terminal 20 to determine whether to visit a store or the like, and enables to promote use of the SNS application.

<Hardware Configuration>

Next, a hardware configuration will be described for each device included in the information processing system 1.

(1) Information Processing Apparatus

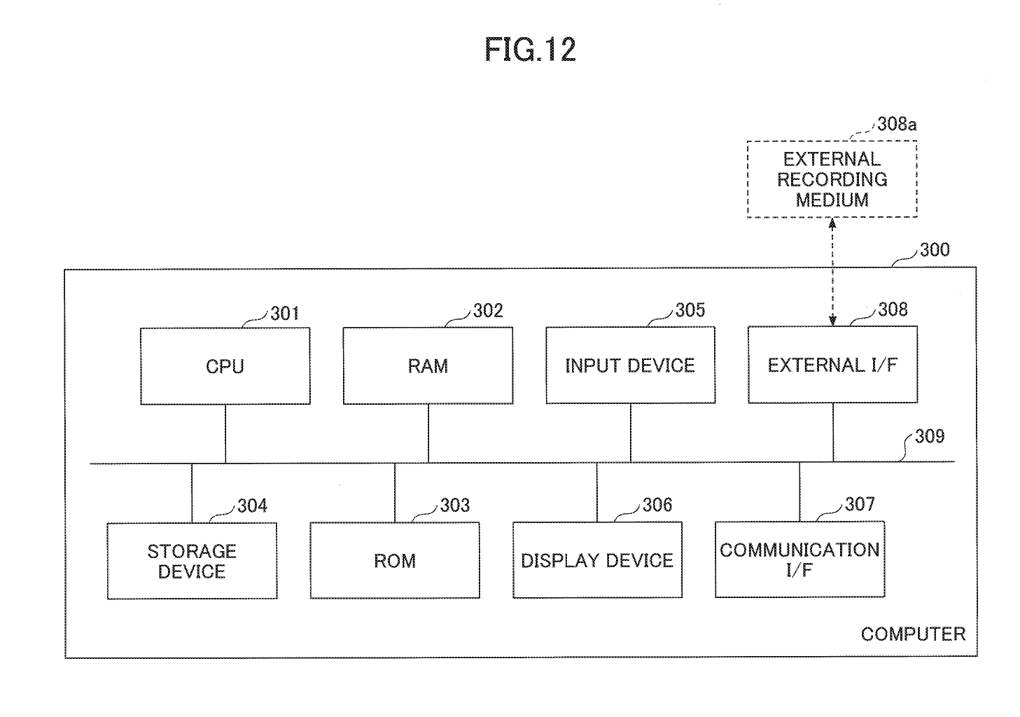

The information processing apparatus 10 has a configuration of a generic computer. FIG. 12 is a diagram illustrating an example of a hardware configuration of a computer according to the first embodiment. In FIG. 12, a computer 300 includes, for example, a CPU (Central Processing Unit) 301, a RAM (Random Access Memory) 302, a ROM (Read-Only Memory) 303, a storage device 304, an input device 305, a display device 306, a communication I/F (Interface) 307, an external I/F 308, and a bus 309.

The CPU 301 is an arithmetic device to implement control and functions of the computer 300 by reading a program and data from a memory such as the ROM 303 and the storage device 304 onto the RAM 302, to execute a process. The ROM 303 stores a BIOS (Basic Input/Output System) executed when activating the computer 300, and programs and data for settings of an OS (Operating System) and for various settings. The RAM 302 is a volatile memory to store programs and data temporarily. The storage device 304 is a mass storage device to store programs and data.

The input device 305 is constituted with, for example, a keyboard and a mouse used by the user to input various operation signals. The display device 306 is, for example, a display to display a result processed by the computer 300. Note that the input device 305 and/or the display device 306 may be connected to be used when necessary.

The communication I/F 307 is an interface for connecting the computer 300 to the network 2. The external I/F 308 is an interface with an external device. The external device may be an external recording medium 308a or the like. Thereby, the computer 300 can execute reading and/or writing on the external recording medium 308a through the external I/F 308. The external recording medium 308a may include various types of optical disks, various types of memory cards, and the like.

The CPU 301 running programs stored in the ROM 303 or the like enables to implement the functions of the information processing apparatus 10.

(2) Terminal

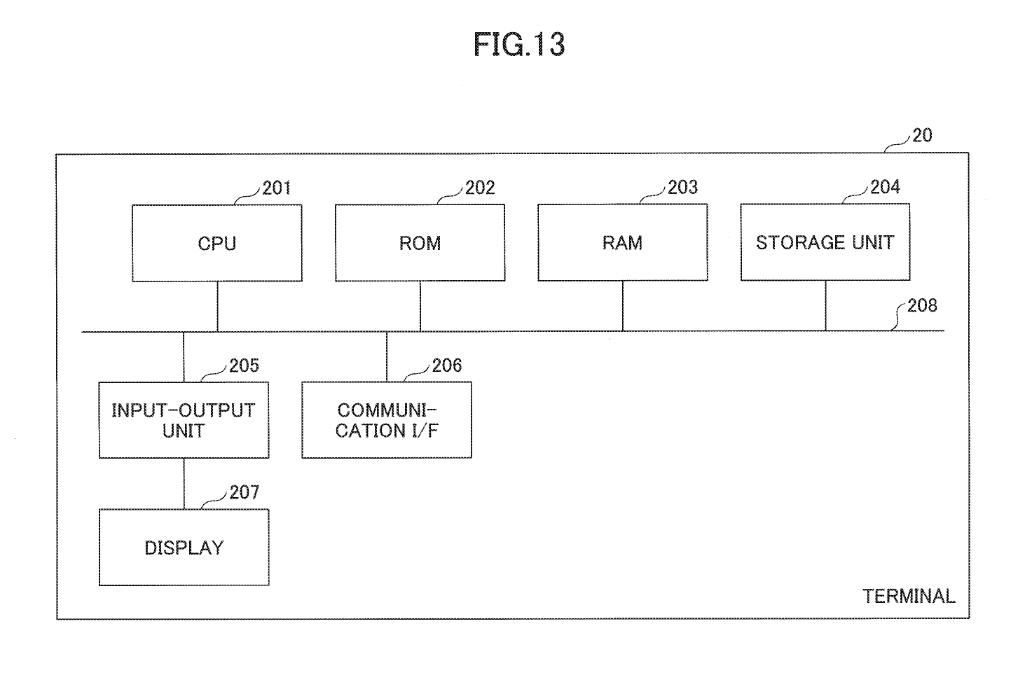

FIG. 13 is a diagram illustrating an example of a hardware configuration of the terminal 20 in the first embodiment.

The terminal 20 includes a CPU 201, a ROM 202, a RAM 203, a storage device 204, an input/output device 205, a communication I/F 206, and a display 207 (a display device). Note that the components of the hardware of the terminal 20 are connected with each other through a bus 208.

The storage device 204 stores various programs. The CPU 201 is a computer to run various programs stored in the storage device 204.

The ROM 202 is a non-volatile memory. The ROM 202 stores various programs, data, and the like that are necessary for the CPU 201 to run the various programs stored in the storage device 204.

The RAM 203 is a main memory unit such as a DRAM (Dynamic Random Access Memory) and an SRAM (Static Random Access Memory). The RAM 203 functions as a work area on which various programs are loaded when executed by the CPU 201.

The input/output device 205 includes a function of an input device to input various commands into the terminal 20, and a function of an output unit to output a processed result processed by the terminal 20. The input/output device 205 is connected to the display 207. In the embodiment, the display 207 may be a touch-sensitive display (a touch panel). The communication I/F 206 executes communication between the terminal 20 and the information processing apparatus 10 through the network 2.

The CPU 201 running programs stored in the storage device 204 or the like enables to implement the functions of the terminal 20.

<Functional Configuration>

(1) Functional Configuration of Information Processing Apparatus

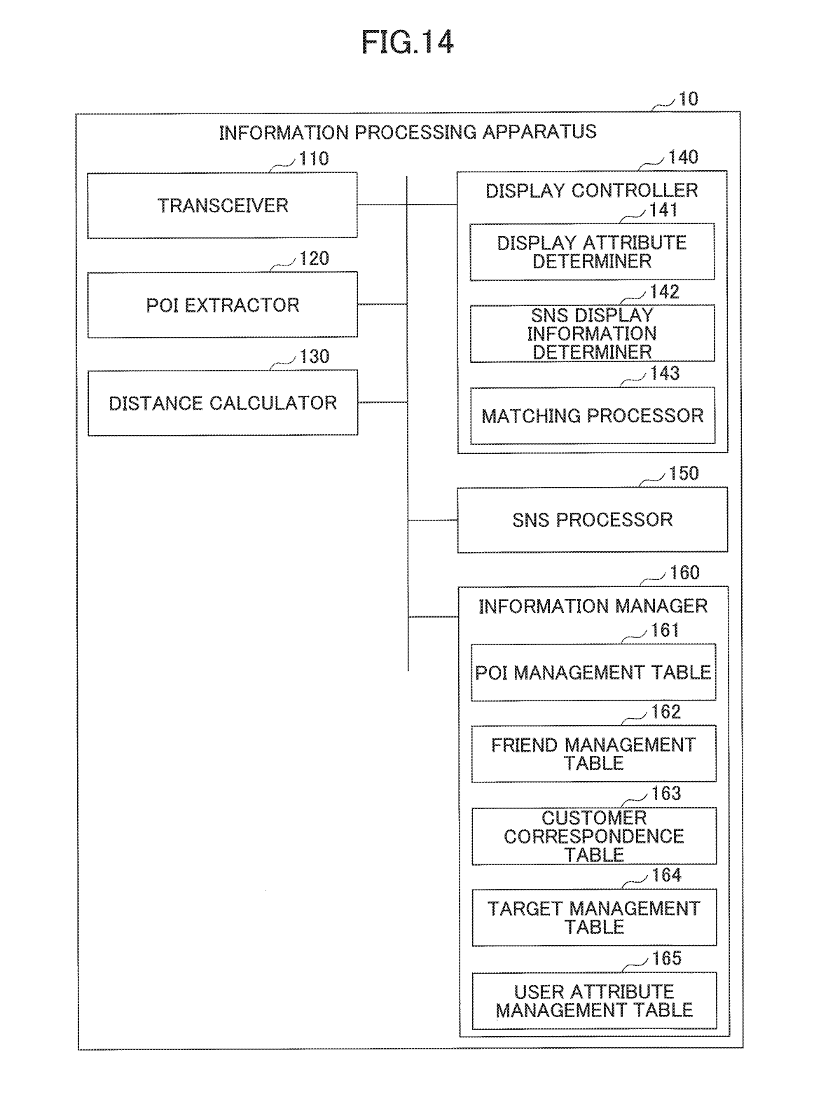

A functional configuration of the information processing apparatus 10 will be described by using FIG. 14. The information processing apparatus 10 includes a transceiver 110, a POI extractor 120, a distance calculator 130, a display controller 140, an SNS processor 150, and an information manager 160. The display controller 140 includes a display attribute determiner 141, an SNS display information determiner 142, and a matching processor 143. Also, the information manager 160 includes a POI management table 161, a friend management table 162, a customer correspondence table 163, a target management table 164, and a user attribute management table 165.

The transceiver 110 transmits and receives data with the terminal 20 through the network 2.

The POI extractor 120 refers to the POI management table 161, to extract each POI corresponding to a keyword (search word) included in a display request of the terminal 20.

The distance calculator 130 calculates the distance between each of the extracted POIs and the reference position included in the display request.

The POI extractor 120 may indicate to the display controller 140 each POI within a predetermined distance from the reference position as the extracted POI.

The display controller 140 determines a displaying aspect of each POI to be displayed on a map on the screen of the terminal 20, and indicates the determined displaying aspect of the POI to the terminal 20 through the transceiver 110.

The display attribute determiner 141 determines the types of attributes of the POI to be displayed on a map based on the distance between the extracted POI and the reference position. The display controller 140 refers to the POI management table 161, to determine the types of attributes of each POI to be displayed on the map. For example, the display controller 140 determines to display a POI on the map on the screen of the terminal 20 with an icon and a mark that constitute information representing the attribute 1 through the attribute 4 in the case where the distance from the reference position is within a first distance; determines to display a POI on the map on the screen of the terminal 20 with an icon and a mark that constitute information representing the attribute 1 and the attribute 2 in the case where the distance from the reference position is greater than the first distance and within a second distance (the first distance<the second distance); and determines to display the existence of a POI on the map on the screen of the terminal 20 in the case where the distance from the reference position is greater than the second distance.

The SNS display information determiner 142 determines whether a store, which corresponds to a POI that exists within a predetermined distance from the reference position (for example, within the second distance), or an organization to which the store belongs bears a relationship with the user of the terminal 20. When making a determination, the identifier of the user included in the display request and the friend management table 162 are used. In the case of bearing a relationship, the SNS display information determiner 142 determines to display information representing that the store corresponding to the POI or the organization to which the store belongs bears a relationship on the map on the screen of the terminal 20. Furthermore, the SNS display information determiner 142 may obtain information relevant to the points of the store or the organization to which the store belongs from the friend management table 162, to determine to display the information.

Also, the SNS display information determiner 142 may determine to display information representing the availability of an inquiry by a chat on an SNS, the availability record, and the like of the store or the like corresponding to a POI that exists within a predetermined distance from the reference position, on the map on the screen of the terminal 20.

The matching processor 143 executes a matching process between a store corresponding to a POI that exists within a predetermined distance from the reference position (for example, within the second distance) or an organization to which the store belongs and the user of the terminal 20. Specifically, the matching processor 143 refers to the target management table 164 and the user attribute management table 165, to identify a store or the like that can be determined to match an interest of the user so as to determine to display information representing the matched interest on the map on the screen of the terminal 20.

The SNS processor 150 provides an SNS service in response to receiving a service provision request of an SNS from the terminal 20. For example, in the case where an SNS service is activated after the terminal 20 has received a selection of a POI from the user, the SNS processor 150 provides the SNS service in response to receiving a request from the terminal 20. Note that the SNS processor 150 may be installed on an information processing apparatus other than the information processing apparatus 10.

The information manager 160 stores various tables. The POI management table 161 stores information items illustrated in FIG. 3. The friend management table 162 stores information items illustrated in FIG. 6. The customer correspondence table 163 stores information items illustrated in FIG. 7. The target management table 164 stores information items illustrated in FIG. 10A. The user attribute management table 165 stores information items illustrated in FIG. 10B.

(2) Terminal

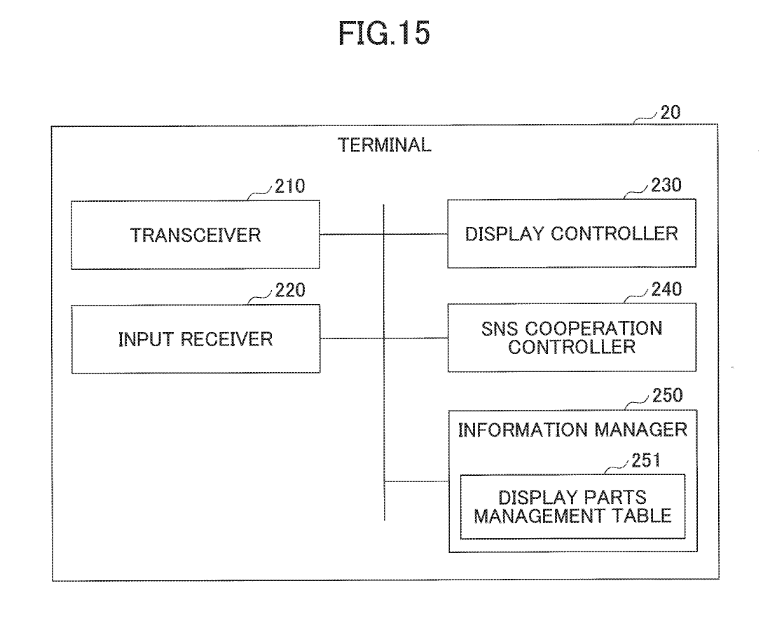

A functional configuration of the terminal 20 will be described by using FIG. 15. The terminal 20 includes a transceiver 210, an input receiver 220, a display controller 230, an SNS cooperation controller 240, and an information manager 250.

The transceiver 210 transmits and receives data with the terminals 20 through the network 2.

The input receiver 220 receives a command to display a map application, an input of a keyword, a command to transmit a display request, and the like from the user of the terminal 20.

The display controller 230 displays a map generated by a map application on the screen of the terminal 20. Also, in response to receiving a response to a display request from the information processing apparatus 10, the display controller 230 displays each POI on a map by a displaying aspect according to a command included in the response. The display controller 230 refers to the display parts management table 251, to identify an icon, a mark, and the like to be used when displaying the POIs on the map.

When the input receiver 220 has received a selection of a POI displayed on a map, the SNS cooperation controller 240 activates an SNS application, and transmits a provision request of an SNS service to the information processing apparatus 10. The SNS cooperation controller 240 may activate a predetermined menu, for example, a chat menu or a friend addition menu of the SNS application, in response to receiving a selection of a POI.

The information manager 250 includes a display parts management table 251. In the display parts management table 251, display parts such as icons (40, 45) each representing a store corresponding to a POI or an organization to which the store belongs, a mark 60 representing that a store is open, a mark 61 representing that a store is closed, and a mark 62 representing that coupons are distributed, are associated with respective identifiers of the display parts, to be stored.

<Flow of Operations>

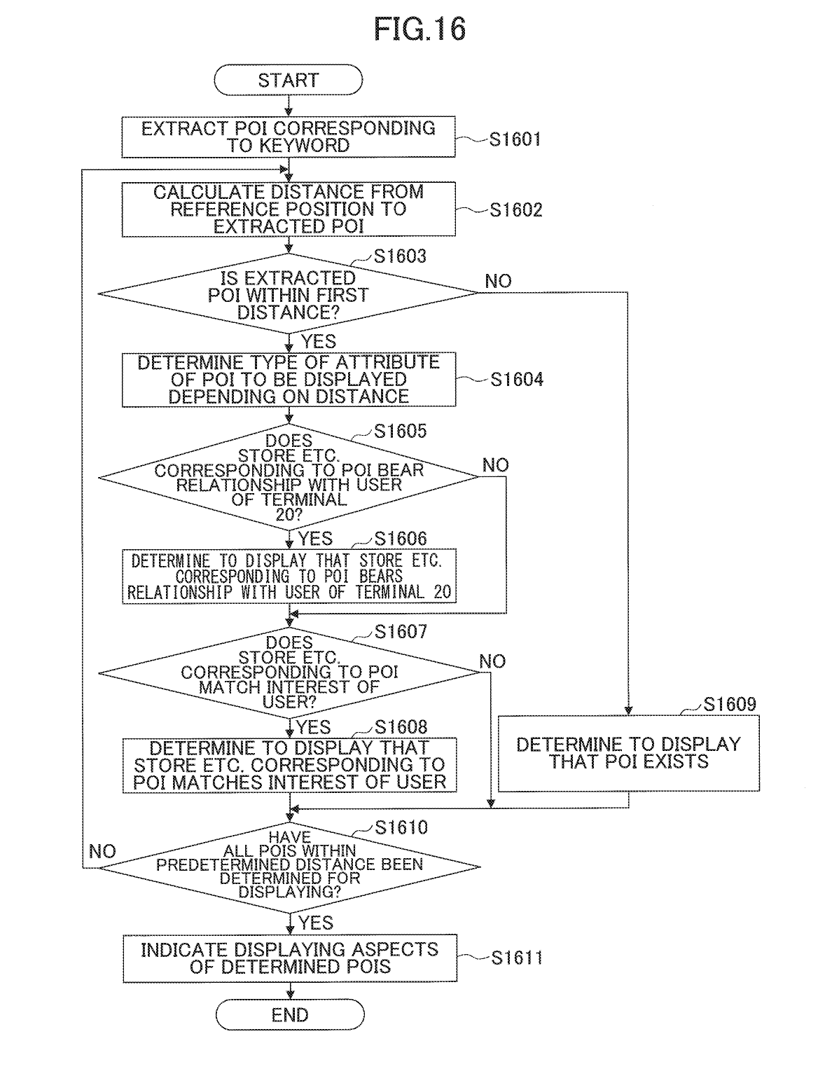

By using FIG. 16, a flow of operations will be described for the information processing apparatus 10 according to the first embodiment.

At Step S1601, once the transceiver 210 of the information processing apparatus 10 has received a display request from the terminal 20 that includes a reference position and a keyword, the POI extractor 120 refers to the POI management table 161, to extract each POI that exists in a predetermined area and corresponds to the keyword. The predetermined area is, for example, the vicinity of “OO district”, “OO station”, or the like.

At Step S1602, the distance calculator 130 calculates the distance from the reference position to each of the extracted POIs.

At Step S1603, the display attribute determiner 141 determines whether the extracted POI is located within the first distance (for example, 500 m). In the case where the distance between the extracted POI and the reference position is within the predetermined distance, the process goes to Step S1604. On the other hand, in the case where the distance between the extracted POI and the reference position is longer than the predetermined distance, the process goes to Step S1609.

At Step S1604, the display attribute determiner 141 determines the types of attributes of the POI to be displayed on the map, based on the distance between the extracted POI and the reference position. The display attribute determiner 141 refers to the POI management table 161, to determine the attributes to be displayed. For example, the display attribute determiner 141 determines to display the POI on the map by using information that represents the attribute 1 through the attribute 4, in the case where the distance between the POI and the reference position is within the second distance (for example, 300 m). The display attribute determiner 141 determines to display the POI on the map by using information that represents the attribute 1 and the attribute 2, in the case where the distance between the POI and the reference position is greater than the second distance.

At Step S1605, the SNS display information determiner 142 refers to the friend management table 162, to determine whether a store or an organization corresponding to the POI bears a relationship with the user of the terminal 20. In the case where it has been determined that the user bears a relationship (YES at Step S1605), the process goes to Step S1606. On the other hand, in the case where it has been determined that the user does not bear a relationship (NO at Step S1605), the process goes to Step S1607.

At Step S1606, the SNS display information determiner 142 determines to display information representing that the store corresponding to the POI or the organization to which the store belongs bears a relationship on the map on the screen of the terminal 20.

At Step S1607, the matching processor 143 executes a matching process by using the target management table 164 and the user attribute management table 165. As a result of the matching process, in the case where the store corresponding to the POI or the organization to which the store belongs is determined to match an interest of the user (YES at Step S1607), the process goes to Step S1608. On the other hand, in the case where it is determined not to match an interest of the user, the process goes to Step S1610.

At Step S1608, the matching processor 143 identifies a POI that can be determined to match an interest of the user, and determines to display the information representing that on a map on the screen of the terminal 20.

In the case where it has been determined NO at Step S1603, the display attribute determiner 141 determines at Step S1609 to display an indication representing that the POI exists.

At Step S1610, the display controller 140 confirms whether a procedure of Step S1602 through Step S1609 has been executed for all of the extracted POIs. In the case where the procedure has been executed for all of the extracted POIs (YES at Step S1610), the process goes to Step S1611. On the other hand, in the case where the procedure has not been executed for all the extracted POIs (NO at Step S1610), the process goes back to Step S1602.

At Step S1611, the transceiver 110 indicates the determined displaying aspects of the POIs to the terminal 20.

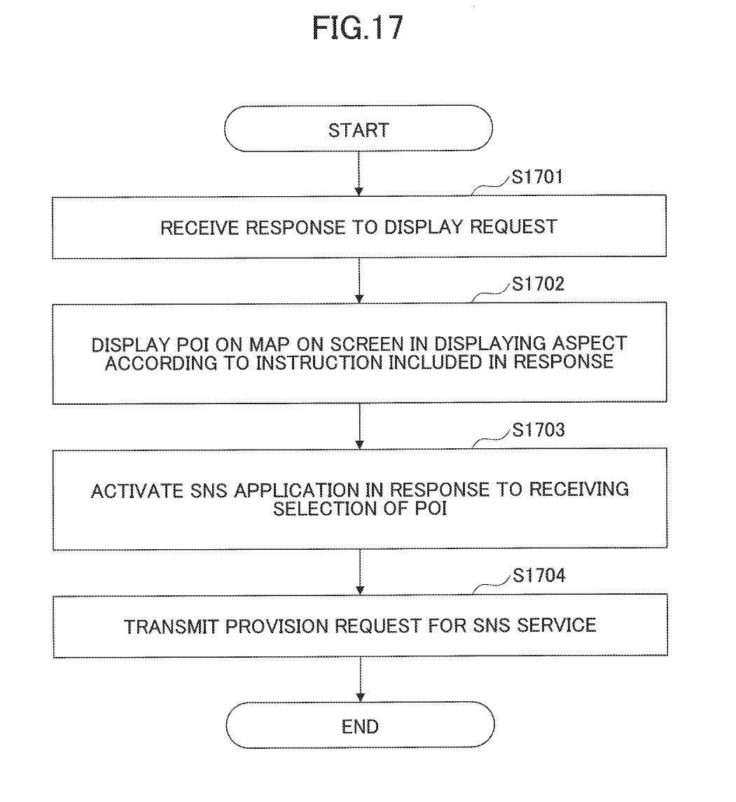

Next, a flow of operations in the terminal 20 will be described by using FIG. 17.

At Step S1701, the transceiver 210 of the terminal 20 receives a response to a display request.

At Step S1702, the display controller 230 displays POIs on the map on the screen of the terminal 20 by respective displaying aspects according to a command included in the response.

At Step S1703, once the input receiver 220 has received a selection of a POI, the SNS cooperation controller 240 activates an SNS application. Here, the SNS cooperation controller 240 may activate a predetermined menu of the SNS.

At Step S1704, in response to receiving a command from the SNS cooperation controller 240, the transceiver 210 transmits a provision request of the SNS service to the information processing apparatus 10.

### Second Embodiment

Next, a second embodiment will be described. In the second embodiment, only a part different from the first embodiment will be described.

In the first embodiment, although the terminal 20 displays each POI by a displaying aspect according to a command from the information processing apparatus 10, the terminal 20 may determine a displaying aspect of the POI.

<Functional configuration>

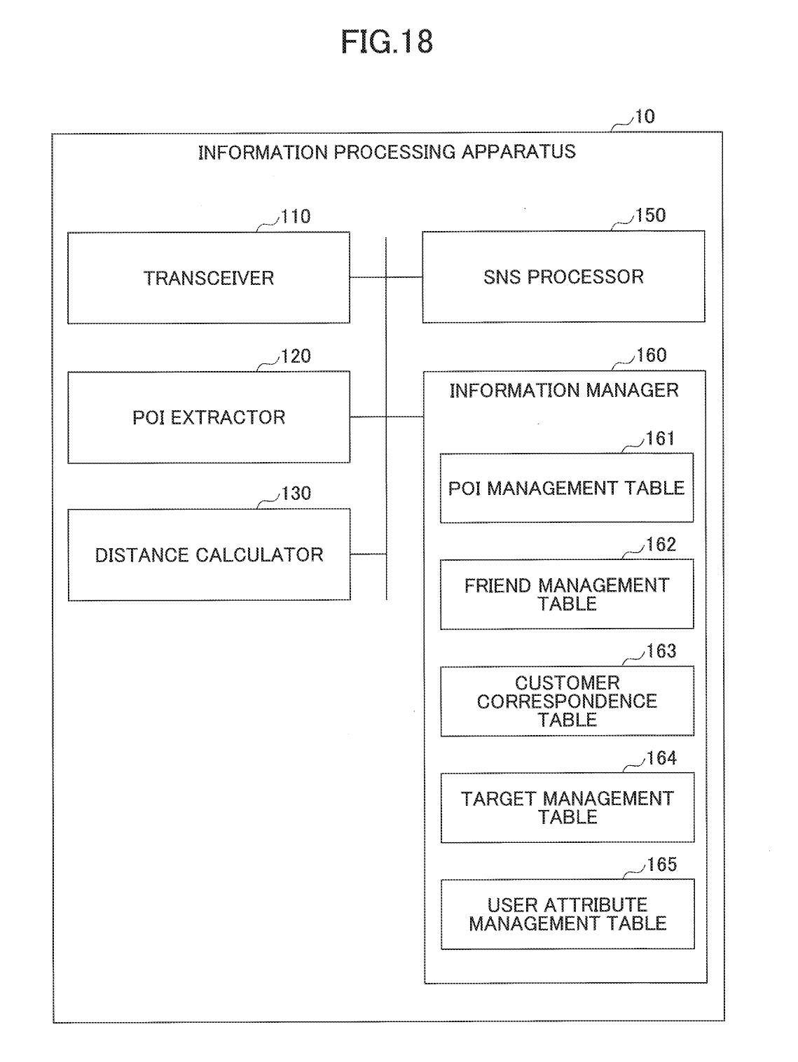

A functional configuration of an information processing apparatus 10 according to the second embodiment will be described by using FIG. 18.

Since the terminal 20 determines the displaying aspect of each POI in the second embodiment, the information processing apparatus 10 according to the second embodiment does not have a display controller 140.

The distance calculator 130 calculates the distance between each extracted POI and the reference position.

The transceiver 110 transmits the extracted POIs and a calculation result of the distances to the terminal 20. Here, the transceiver 110 may transmit POIs whose calculated distances are within the predetermined distance, and the distances between such POIs and the reference position to the terminal 20.

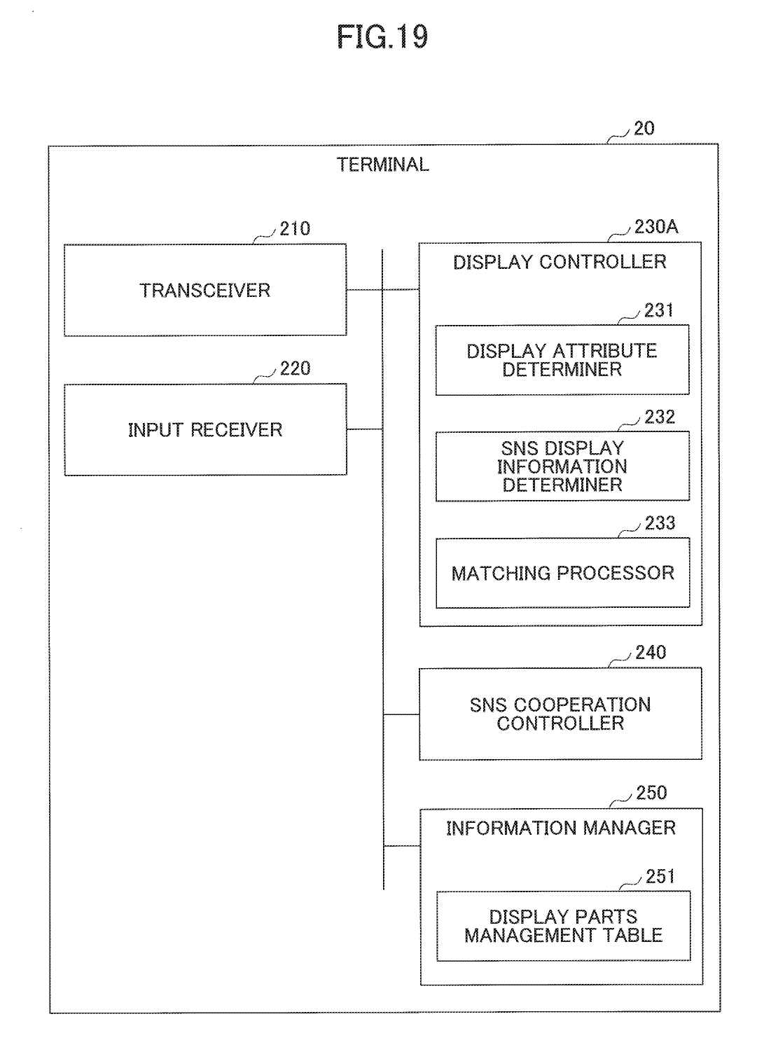

A functional configuration of the terminal 20 according to the second embodiment will be described by using FIG. 19.

A display controller 230A of the terminal 20 according to the second embodiment includes a display attribute determiner 231, an SNS display information determiner 232, and a matching processor 233.

Once the transceiver 210 has received extracted POIs and the distances between these POI and the reference position as a response to a display request, the display controller 230 identifies POIs within the first distance (for example, 500 m) from the reference position. For POIs separated by the first distance or greater, the display controller 230A determines to display marks representing the existence of the POIs on the map. On the other hand, for POIs within the first distance from the reference position, the display controller 230A determines to display the POIs with their attributes and the like.

Functions of the display attribute determiner 231, the SNS display information determiner 232, and the matching processor 233 are the same as the functions included in the display attribute determiner 141, the SNS display information determiner 142, and the matching processor 143 in the first embodiment, respectively. These functional blocks refer to various tables stored in the information manager 160 of the information processing apparatus 10 through the transceiver 110, to determine displaying aspects of the POIs within the first distance.

Note that in the second embodiment, although the distance calculator 130 is installed in the information processing apparatus 10, the same function may be installed in the terminal 20.

[Other]

Although stores are mainly taken as examples of POIs and are described in the above embodiments, POIs may be sightseeing spots such as shrines, temples, and landmarks, and/or public facilities such as libraries and gymnasiums. In the case where the user of an SNS bears a friendly relationship with a sightseeing site, and/or in the case of bearing a friendly relationship with a public organization, sightseeing spots and/or public facilities as POIs may be controlled by the terminal 20 and/or the information processing apparatus so that the relationships held with the user are displayed on a map displayed on the terminal 20 of the user.

The transceiver 110 is an example of a receiver. The POI extractor 120 and the distance calculator 130 are examples of extracting. The transceiver 210 is an example of a transmitter and obtaining. Also, a search result is an example of a facility of a store and the like.

A recording medium storing a program code of software that implements functions of an embodiment described above may be supplied to the information processing apparatus 10 and the terminal 20. Furthermore, it is needless to say that an embodiment described above is realized by the information processing apparatus 10 and the terminal 20 that read the program code stored in the recording medium, and execute the program code. In this case, a program that causes the information processing apparatus 10 and the terminal 20 to execute a display control method described above is stored in the recording medium.

Specifically, a program is stored in the recording medium that causes an information processing apparatus to execute a process that includes a step of receiving a display request that includes information on a reference position and a search word from a terminal; a step of extracting a search result based on the reference position and the search word; and a step of identifying an attribute associated with the obtained search result, and issuing a command to the terminal to display information representing the attribute at a position corresponding to the search result on a map displayed on a screen of the terminal. A type and/or a quantity of the information representing the attribute to be displayed is adjusted depending on a distance between the reference position and the position corresponding to the extracted search result.

Also, a program is stored in the recording medium that causes a terminal to execute a process that includes a step of transmitting a display request that includes information on a reference position and a search word to an information processing apparatus; a step of obtaining a search result extracted by the information processing apparatus based on the reference position and the search word, and a position corresponding to the search result; and a step of identifying an attribute associated with the obtained search result, and displaying information representing the attribute at the position corresponding to the search result on a map displayed on a screen. A type and/or a quantity of the information representing the attribute to be displayed is adjusted depending on a distance between the reference position and the position corresponding to the extracted search result.

Furthermore, the program code itself read out of these recording media realizes the functions of the embodiments described earlier.

Also, implementation of the functions of an embodiment described earlier is not limited to execution by a computer device that has read the program code. An operating system (OS) or the like running on the computer device according to instructions of the program code may execute processing partially or entirely. Furthermore, it is needless to say that the functions of the embodiment described earlier may be realized by such processing.

As above, favorable embodiments of the present invention have been described. Note that the present invention is not limited to such embodiments, and various modifications and substitutions can be made without deviating from the scope of the subject matters of the present invention.

1. An information processing apparatus comprising:
a receiver configured to receive from a terminal a display request that includes information on a reference position and a search word;
a memory; and
a processor configured to execute
extracting a search result based on the reference position and the search word, and
display-controlling by identifying an attribute associated with the extracted search result, and issuing a command to the terminal to display information representing the attribute at a position corresponding to the search result on a map displayed on a screen of the terminal,
wherein the display-controlling adjusts a type and/or a quantity of the information representing the attribute to be displayed depending on a distance between the reference position and the position corresponding to the extracted search result.

2. The information processing apparatus as claimed in claim 1, wherein a variety of the type and/or the quantity of the information representing the attribute of the search result to be displayed are greater when the distance is shorter.

3. The information processing apparatus as claimed in claim 1, wherein the display-controlling determines whether the search result or an organization to which the search result belongs bears a relationship with a user of the terminal, and in a case of having determined that the relationship exists, issues a command to the terminal to display information representing that the relationship exists, at the position corresponding to the search result on the map.

4. The information processing apparatus as claimed in claim 3, wherein the display-controlling determines that the relationship exists in a case where the search result or the organization is registered as a friend in an account of the user on a social networking service.

5. The information processing apparatus as claimed in claim 3, wherein in the case of having determined that the relationship exists, the display-controlling issues a command to the terminal to display information regarding points that have been given to the user by the search result or the organization.

6. The information processing apparatus as claimed in claim 1, wherein the display-controlling issues a command to the terminal to display information representing an evaluation made by other users of the search result or the organization to which the search result belongs at the position of the search result on the map.

7. The information processing apparatus as claimed in claim 1, wherein the display-controlling determines whether the attribute of the user of the terminal matches a user targeted by the search result or the organization to which the search result belongs, and in a case of having determined that the attribute matches, issues a command to the terminal to display information representing that the attribute of the user is matched, at the position on the map.

8. The information processing apparatus as claimed in claim 1, wherein the information is displayed by an icon, a mark, a highlighting display, an animation display, a text display, or a combination of these.

9. A non-transitory computer-readable recording medium having a program stored therein for causing a terminal to execute a process, the process comprising:
a step of transmitting a display request that includes information on a reference position and a search word to an information processing apparatus;
a step of obtaining a search result extracted by the information processing apparatus based on the reference position and the search word, and a position corresponding to the search result; and
a step of identifying an attribute associated with the obtained search result, and displaying information representing the attribute at the position corresponding to the search result on a map displayed on a screen,
wherein a type and/or a quantity of the information representing the attribute to be displayed is adjusted depending on a distance between the reference position and the position corresponding to the extracted search result.

10. The non-transitory computer-readable recording medium as claimed in claim 9, the program for causing the terminal to execute the process further comprising:
a step of activating a predetermined menu of a social networking service in response to receiving a selection of the position.

11. The non-transitory computer-readable recording medium as claimed in claim 10, wherein the predetermined menu is a menu of a chat service or a menu of friend registration.

12. A terminal comprising:
a transmitter configured to transmit a display request that includes information on a reference position and a search word to an information processing apparatus;
a memory; and
a processor configured to execute
obtaining a search result extracted by the information processing apparatus based on the reference position and the search word, and a position corresponding to the search result; and
display-controlling by identifying an attribute associated with the obtained search result, and displaying information representing the attribute at the position corresponding to the search result on a map displayed on a screen,
wherein the display-controlling adjusts a type and/or a quantity of the information representing the attribute to be displayed depending on a distance between the reference position and the position corresponding to the extracted search result.

13. A display control method, the method comprising:
a step executed by a terminal for transmitting a display request that includes information on a reference position and a search word to an information processing apparatus;
a step executed by the information processing apparatus for extracting a search result based on the reference position and the search word;
a step executed by the information processing apparatus for identifying an attribute associated with the extracted search result, and issuing a command to the terminal to display information representing the attribute; and
a step executed by a terminal for displaying information representing the attribute at the position corresponding to the search result on a map displayed on a screen, in accordance with the command from the information processing apparatus,
wherein the information processing apparatus of the terminal adjusts a type and/or a quantity of the information representing the attribute to be displayed, depending on a distance between the reference position and the position corresponding to the extracted search result.
